(19) United States
(12) Patent Application Publication
(10) Pub. No.: US 2022/0357786 A1
(43) Pub. Date: Nov. 10, 2022

(54) METHOD AND SYSTEM FOR REDUCING POWER CONSUMPTION BY AUTOMATICALLY ALLOCATING COMPUTING RESOURCES ON THE BASIS OF COMPONENT TEMPERATURE

(71) Applicant: INSPUR SUZHOU INTELLIGENT TECHNOLOGY CO., LTD., Suzhou, Jiangsu (CN)

(72) Inventor: Bin ZONG, Suzhou, Jiangsu (CN)

(21) Appl. No.: 17/764,422

(22) PCT Filed: Apr. 27, 2020
(86) PCT No.: PCT/CN2020/087163

§ 371 Date: Mar. 28, 2022

(30) Foreign Application Priority Data
Sep. 27, 2019 (CN) 201910921890.2

(51) Int. Cl. G06F 1/329; G06F 11/30

(52) U.S. Cl. CPC G06F 1/329; G06F 11/3058

(57) ABSTRACT

Provided are a method and a system for reducing power consumption by automatically allocating computing resources on the basis of component temperature. The method specifically comprises: acquiring temperature values of N components of the same type at a current sampling time; calculating an average temperature value T of the components of the same type at the current sampling time and determining an upper temperature threshold Tmax and a lower temperature threshold Tmin; determining a high-temperature component Ai, a low-temperature component Bj and a normal-temperature component Ck; allocating 10% of computing resources of the high-temperature component Ai to the low-temperature component Bj, wherein the components continuously run for one cycle after the allocation; and repeating the steps after one cycle is finished.

### CROSS-REFERENCE TO RELATED APPLICATIONS

The present application claims priority to Chinese patent application No. 201910921890.2, entitled “METHOD AND SYSTEM FOR REDUCING POWER CONSUMPTION BY AUTOMATICALLY ALLOCATING COMPUTING RESOURCES ON THE BASIS OF COMPONENT TEMPERATURE” and filed to China National Intellectual Property Administration on Sep. 27, 2019, the entire contents of which is incorporated herein by reference.

### TECHNICAL FIELD

The present invention relates to the technical field of server fan regulation, in particular to a method and a system for reducing power consumption by automatically allocating computing resources on the basis of component temperature.

### BACKGROUND

The development of novel technologies such as cloud computing and big data is posing higher and higher requirements on the bandwidth and capacity of data storage, and the operation speed and the operation amount of a processor are also increasingly higher, which results in soaring temperature of components such as a memory and a hard disk. Heat dissipation of electronic components becomes a very knotty problem at present; besides, in current society, it is required that power consumption should be lower and lower, and energy conservation is a mainstream trend at present. How to effectively reduce the over-high temperature of electronic components and the power consumption of the fan wall and thereby realize optimal power consumption of the whole machine is a technical problem which needs to be solved urgently.

In the prior art, computing resources are allocated evenly among components of the same type. After receiving a computing instruction, the BMC issues the computing instruction to the components of the same type in a balanced manner, and the components are allocated with the same amount of resource loading to complete the same computing task, and namely the components under different environmental conditions need to complete the same task.

In the prior art, allocating computing resources evenly among components of the same type is unfavorable for corresponding components under boundary conditions of high incoming flow temperature and low wind speed, and the components under severe conditions will require more resources and more wind flow. The required wind flow is a limited amount of wind flow that is acquired on the basis of integral wind flow improvement, and the integral rotating speed of a fan wall will be raised, the power consumption of the whole machine and the PUE value of the system are increased, and thus the operation cost is increased.

### SUMMARY

Embodiments of the present invention provides a method and a system for reducing power consumption by automatically allocating computing resources on the basis of component temperature. By automatically allocating computing resources on the basis of component temperature, devices under different boundary conditions are each allocated with matched computing amount and thereby the temperature values of devices of the same type are substantially controlled to be the same. The method and the system described in the embodiments of the present invention solve the problem that: in a system architecture where components of the same type are allocated with the same amount of resource loading, the rotating speed of the control fan is raised due to the extremely high temperature of the components under the boundary condition and thus the power consumption of the whole machine and the PUE value of the system are increased.

The embodiment of the present invention discloses the following technical schemes.

In a first aspect, the present invention provides a method for reducing power consumption by automatically allocating computing resources on the basis of component temperature, which comprises:

S1, acquiring temperature values of N components of the same type at a current sampling time;

S2, calculating an average temperature value T of the components of the same type at the current sampling time, determining an upper temperature threshold Tmax and a lower temperature threshold Tmin, wherein the upper temperature threshold Tmax=T+3° C., the lower temperature threshold Tmin=T−3° C.;

S3, determining a high-temperature component Ai, a low-temperature component Bj and a normal-temperature component Ck, wherein i is a serial number of the high-temperature component among a total of I high-temperature components; j is a serial number of the low-temperature component among a total of J high-temperature components; k is a serial number of the normal-temperature component among a total of K high-temperature components; and 0≤i≤I, 0≤j≤J, 0≤k≤K, I+J+K=N;

S4, allocating 10% of computing resources of the high-temperature component Ai to the low-temperature component Bj, wherein the components continuously run for one cycle after the allocation; and

S5, repeating the S1-S4.

Further, in the S3, the method of determining a high-temperature component Ai, a low-temperature component Bj and a normal-temperature component Ck is:

S31, determining whether a temperature value of a single component is >Tmax, if yes, regarding the single component as the high-temperature component Ai;

S32, determining whether a temperature value of a single component is <Tmin, if yes, regarding the single component as the low-temperature component Bj; and

S33, determining whether Tmin≤a temperature value of a single component ≤Tmax, if yes, regarding the single component as the normal-temperature component.

Further, in the S4, the method of allocating 10% of computing resources of the high-temperature component Ai to the low-temperature component Bj is:

S41, sorting the I high-temperature components in a descending order by temperature into A1, A2, A3, . . . , Ai, . . . , AI;

S42, sorting the J low-temperature components in an ascending order by temperature into B1, B2, B3, . . . , Bj, . . . , BJ;

S43, if I>J, allocating 10% of the computing resources of the high-temperature components A1, A2, A3, . . . , Aj, . . . , AJ to the low-temperature components B1, B2, B3, . . . , Bj, . . . , BJ according to S45;

S44, if I<J, allocating 10% of the computing resources of the high-temperature components A1, A2, A3, . . . , Ai, . . . , AI to the low-temperature components B1, B2, B3, . . . , Bi, . . . , BI according to S45; and

S45, if I=J,

allocating 10% of the computing resources of the high-temperature component A1 to the low-temperature component B1,

allocating 10% of the computing resources of the high-temperature component A2 to the low-temperature component B2,

allocating 10% of the computing resources of the high-temperature component A3 to the low-temperature component B3,

. . . ,

allocating 10% of the computing resources of the high-temperature component Ai to the low-temperature component Bj,

. . . ,

allocating 10% of the computing resources of the high-temperature component AI to the low-temperature component BJ.

Further, the components of the same type in the method are CPUs, GPUs or PCIEs, N≥2.

Further, the cycle of the method is 1 min.

In a second aspect, the present invention provides a system for reducing power consumption by automatically allocating computing resources on the basis of component temperature, which comprises:

a data acquisition unit for acquiring temperature values of N components of the same type at a current sampling time;

a data calculation unit for calculating an average temperature value T of the components of the same type at the current sampling time and determining an upper temperature threshold Tmax and a lower temperature threshold Tmin, wherein the upper temperature threshold Tmax=T+3° C., the lower temperature threshold Tmin=T−3° C.;

a data determination unit for determining a high-temperature component Ai, a low-temperature component Bj and a normal-temperature component Ck, wherein i is a serial number of the high-temperature component among a total of I high-temperature components; j is a serial number of the low-temperature component among a total of J high-temperature components; k is a serial number of the normal-temperature component among a total of K high-temperature components; and 0≤i≤I, 0≤j≤J, 0≤k≤K, I+J+K=N;

a data allocation unit for allocating 10% of computing resources of the high-temperature component Ai to the low-temperature component Bj, wherein the components continuously run for one cycle after the allocation; and

a data circulation unit for skipping to the data acquisition unit after the data allocation unit finishes its task.

Further, the data determination unit comprises:

a high-temperature component determination module for determining whether a temperature value of a single component is >Tmax, if yes, regarding the single component as the high-temperature component Ai;

a low-temperature component determination module for determining whether a temperature value of a single component is <Tmin when the temperature value of the single component is ≤Tmax, if yes, regarding the single component as the low-temperature component Bj; and

a normal-temperature component determination module for determining whether Tmin≤a temperature value of a single component≤Tmax, if yes, regarding the single component as the normal-temperature component.

Further, the data allocation unit comprises:

a first sorting module for sorting the I high-temperature components in a descending order by temperature into A1, A2, A3, . . . , Ai, . . . , AI;

a second sorting module for sorting the J low-temperature components in an ascending order by temperature into B1, B2, B3, . . . , Bj, . . . , BJ;

a comparison module of high-temperature and low-temperature components for comparing the number I of high-temperature components with the number J of low-temperature components, wherein

if I>J, computing resource allocation tasks are performed for the high-temperature components A1, A2, A3, . . . , Aj, . . . , AJ and the low-temperature components B1, B2, B3, . . . , Bj, . . . , BJ according to a data allocation module,

if I<J, computing resource allocation tasks are performed for the high-temperature components A1, A2, A3, . . . , Ai, . . . , AI and the low-temperature components B1, B2, B3, . . . , Bi, . . . , BI according to the data allocation module; and

the data allocation module for, when I=J,

allocating 10% of the computing resources of the high-temperature component A1 to the low-temperature component B1,

allocating 10% of the computing resources of the high-temperature component A2 to the low-temperature component B2,

allocating 10% of the computing resources of the high-temperature component A3 to the low-temperature component B3,

. . . ,

allocating 10% of the computing resources of the high-temperature component Ai to the low-temperature component Bj,

. . . ,

allocating 10% of the computing resources of the high-temperature component AI to the low-temperature component BJ.

The effects provided in the summary are only the effects of the embodiments but not all the effects of the present invention, one of the above technical schemes has the following advantages or beneficial effects:

According to the method and the system for reducing power consumption by automatically allocating computing resources on the basis of component temperature provided in the embodiments of the present invention, in one cycle, temperature values of components of the same type at a current sampling time are acquired, 10% of computing resources of the components with a temperature value above an upper temperature threshold are allocated to the components with a temperature value below a lower temperature threshold, and thus the temperature of a high-temperature component is reduced by reducing its computing resource loading. As a result, a sufficient computing amount of each component can be ensured, and that components under different boundary conditions are each allocated with matched computing amount is also ensured, and the temperature values of components of the same type are substantially controlled to be the same. The method and the system described in the embodiments of the present invention solve the problem that: in a system architecture where components of the same type are allocated with the same amount of resource loading, the rotating speed of the control fan is raised due to the extremely high temperature of the components under the boundary condition and thus the power consumption of the whole machine and the PUE value of the system are increased.

When the method and the system described in the embodiments of the present invention are applied to server universal machines with CPUs, GPUs, PCIEs or other high-power-consumption chip controller components, if a plurality of components of the same type are present, the algorithm of the present invention can ensure sufficient computing resources under different working conditions, effectively reduce the rotating speed of the fan and control the temperature of each component to be within the required threshold value, thereby reducing the power consumption of the whole machine, lowering the noise, realizing optimized design and wide application.

### BRIEF DESCRIPTION OF THE DRAWINGS

In order to more clearly illustrate the embodiments of the present invention or technical schemes in the prior art, the drawings used in the description of the embodiments or prior art will be briefly described below. It is apparent that other drawings can be derived from these drawings by those of ordinary skilled in the art without creative efforts.

FIG. 1 is a flowchart of the method of the present invention;

FIG. 2 is a flowchart illustrating step S4 of the present invention, namely allocating 10% of computing resources of the high-temperature component Ai to the low-temperature component Bj; and

FIG. 3 is a block diagram illustrating the structure of the system of the present invention.

### DETAILED DESCRIPTION

In order to clearly illustrate the technical features of the present technical scheme, the present invention is explained in detail by the following embodiments and the accompanying drawings. The following disclosure provides many different embodiments or examples for implementing different structures of the present invention. To simplify the disclosure of the present invention, components and arrangements of specific examples are described below. Moreover, reference numerals and/or letters may be repeated in the various examples of the present invention. This repetition is for the purpose of simplicity and clarity and does not in itself indicate a relationship between the various embodiments and/or arrangements discussed. It should be noted that the components illustrated in the accompanying drawings are not necessarily drawn to scale. Descriptions of well-known components and processing techniques and processes are omitted to avoid that the present invention is unnecessarily limited.

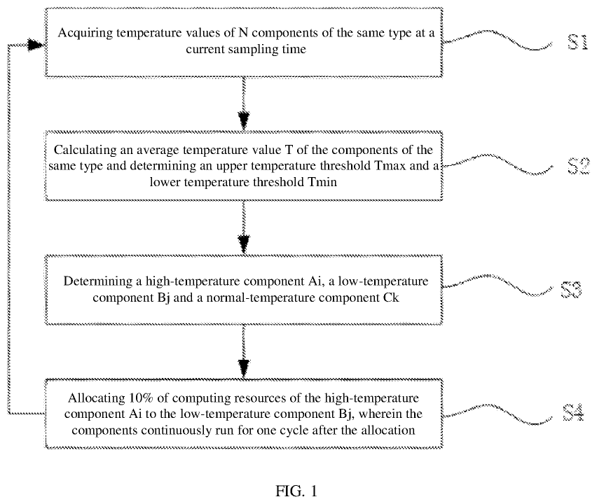

FIG. 1 shows a flowchart of a method for reducing power consumption by automatically allocating computing resources on the basis of component temperature provided herein, wherein the method comprises:

S1, acquiring temperature values of N components of the same type at a current sampling time;

S2, calculating an average temperature value T of the components of the same type at the current sampling time, determining an upper temperature threshold Tmax and a lower temperature threshold Tmin, wherein the upper temperature threshold Tmax=T+3° C., the lower temperature threshold Tmin=T−3° C.;

S3, determining a high-temperature component Ai, a low-temperature component Bj and a normal-temperature component Ck, wherein i represents a serial number of the high-temperature component among a total of I high-temperature components; j represents a serial number of the low-temperature component among a total of J high-temperature components; k represents a serial number of the normal-temperature component among a total of K high-temperature components; and 0≤i≤I, 0≤j≤J, 0≤k≤K, I+J+K=N;

S4, allocating 10% of computing resources of the high-temperature component Ai to the low-temperature component Bj, wherein the components continuously run for one cycle after the allocation; and

S5, repeating the S1-S4.

The S3, determining a high-temperature component Ai, a low-temperature component Bj and a normal-temperature component Ck comprises:

S31, determining whether a temperature value of a single component is >Tmax, if yes, regarding the single component as the high-temperature component Ai;

S32, determining whether a temperature value of a single component is <Tmin, if yes, regarding the single component as the low-temperature component Bj; and

S33, determining whether Tmin≤a temperature value of a single component≤Tmax, if yes, regarding the single component as the normal-temperature component.

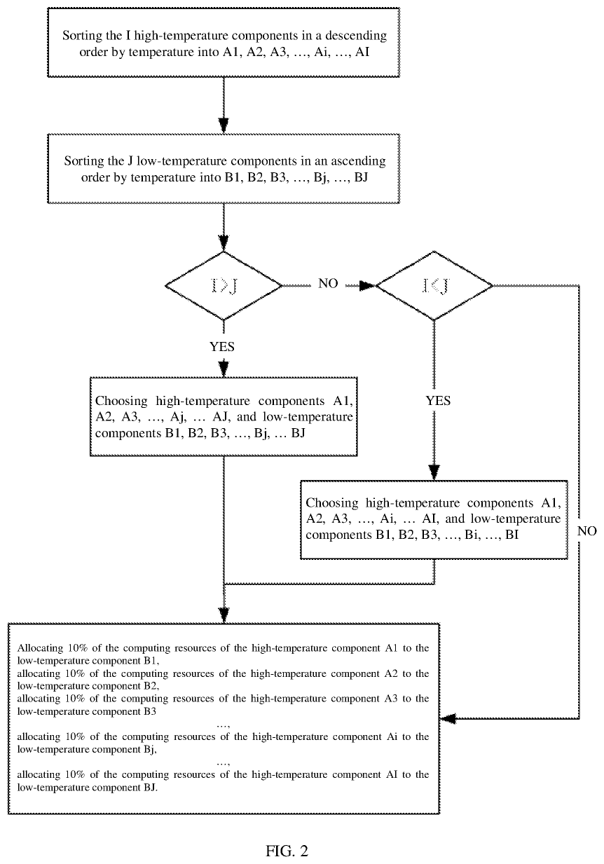

FIG. 2 is a flowchart of S4, allocating 10% of computing resources of the high-temperature component Ai to the low-temperature component Bj, which specifically comprises:

S41, sorting the I high-temperature components in a descending order by temperature into A1, A2, A3, . . . , Ai, . . . , AI;

S42, sorting the J low-temperature components in an ascending order by temperature into B1, B2, B3, . . . , Bj, . . . , BJ;

S43, if I>J, allocating 10% of the computing resources of the high-temperature components A1, A2, A3, . . . , Aj, . . . , AJ to the low-temperature components B1, B2, B3, . . . , Bj, . . . , BJ according to S45;

S44, if I<J, allocating 10% of the computing resources of the high-temperature components A1, A2, A3, . . . , Ai, . . . , AI to the low-temperature components B1, B2, B3, . . . , Bi, . . . , BI according to S45; and

S45, if I=J, allocating 10% of the computing resources of the high-temperature component A1 to the low-temperature component B1, allocating 10% of the computing resources of the high-temperature component A2 to the low-temperature component B2, allocating 10% of the computing resources of the high-temperature component A3 to the low-temperature component B3, . . . , allocating 10% of the computing resources of the high-temperature component Ai to the low-temperature component Bj, . . . , allocating 10% of the computing resources of the high-temperature component AI to the low-temperature component BJ.

A CPU in a server is used as an example for illustration. For example, the server has 8 CPUs in total, that is, N=8, the temperature of the CPUs at a current sampling time is shown in the table below:

| CPU serial | | | | | | | | |
|---|---|---|---|---|---|---|---|---|
| number | CPU1 | CPU2 | CPU3 | CPU4 | CPU5 | CPU6 | CPU7 | CPU8 |
| Current | 72 | 75 | 70.5 | 82 | 83 | 81 | 67 | 69.5 |
| temperature (° C.) | | | | | | | | |

The implementation steps are as follows:

1) acquiring temperature values of the CPUs at a current time (see table above);

2) calculating an average temperature T of the CPUs (T=75° C.),

determining an upper temperature threshold Tmax (78° C.),

determining a lower temperature threshold Tmin (72° C.);

3) according to step 2), determining that CPUs with a temperature above 78° C. are high-temperature components, namely three high-temperature components CPU4 (82° C.), CPUS (83° C.) and CPU6 (81° C.), determining that CPUs with a temperature below 72° C. are low-temperature components, namely three low-temperature components CPU3 (70.5° C.), CPU7 (67° C.) and CPU8 (69.5° C.), the rest 2 CPUs being normal-temperature components;

4) allocating computing resources:

4.1) sorting the three high-temperature CPUs in a descending order, with A1 being CPUS (83° C.), A2 being CPU4 (82° C.), A3 being CPU6 (81° C.),

4.2) sorting the three low-temperature CPUs in an ascending order, with B1 being CPU7 (67° C.), B2 being CPU8 (69.5° C.), B3 being CPU3 (70.5° C.),

4.3) if the number of high-temperature CPUs and the number of low-temperature CPUs are equal,

allocating 10% of the computing resources of the A1 high-temperature CPUS (83° C.) to the B1 low-temperature CPU7 (67° C.),

allocating 10% of the computing resources of the A2 high-temperature CPU4 (82° C.) to the B2 low-temperature CPU8 (69.5° C.),

allocating 10% of the computing resources of the A3 high-temperature CPU6 (81° C.) to the B3 low-temperature CPU3 (70.5° C.); and

5) repeating the steps 1)-4).

By using the method for reducing power consumption by automatically allocating computing resources on the basis of component temperature described herein, the CPUs under different boundary conditions can be allocated with the matched computing amount, thus the temperature values of the CPUs are substantially controlled to be the same and the computing resources are reasonably allocated to the CPUs.

In the method described in the embodiments of the present invention, the components of the same type are CPUs, GPUs or PCIEs, N≥2, the cycle is 1 min, other time that conforms to the actual operation can be used as the cycle in the present invention.

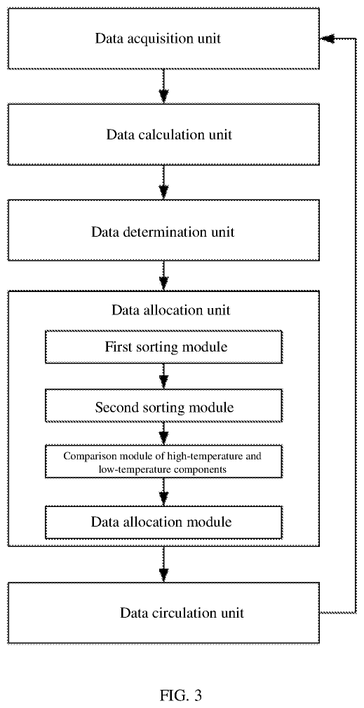

FIG. 3 shows a block diagram illustrating the structure of a system for reducing power consumption by automatically allocating computing resources on the basis of component temperature provided herein, wherein the system comprises:

a data acquisition unit for acquiring temperature values of N components of the same type at a current sampling time;

a data calculation unit for calculating an average temperature value T of the components of the same type at the current sampling time and determining an upper temperature threshold Tmax and a lower temperature threshold Tmin, wherein the upper temperature threshold Tmax=T+3° C., the lower temperature threshold Tmin=T−3° C.;

a data determination unit for determining a high-temperature component Ai, a low-temperature component Bj and a normal-temperature component Ck, wherein i represents a serial number of the high-temperature component among a total of I high-temperature components; j represents a serial number of the low-temperature component among a total of J high-temperature components; k represents a serial number of the normal-temperature component among a total of K high-temperature components; and 0≤i≤I, 0≤j≤J, 0≤k≤K, I+J+K=N;

a data allocation unit for allocating 10% of computing resources of the high-temperature component Ai to the low-temperature component Bj, wherein the components continuously run for one cycle after the allocation; and

a data circulation unit for skipping to the data acquisition unit after the data allocation unit finishes its task.

The data determination unit comprises:

a high-temperature component determination module for determining whether a temperature value of a single component is >Tmax and, if yes, regarding the single component as the high-temperature component Ai;

a low-temperature component determination module for determining whether a temperature value of a single component is <Tmin when the temperature value of the single component is ≤Tmax and, if yes, regarding the single component as the low-temperature component Bj; and

a normal-temperature component determination module for determining whether Tmin≤a temperature value of a single component≤Tmax and, if yes, regarding the single component as the normal-temperature component.

The data allocation unit comprises:

a first sorting module for sorting the I high-temperature components in a descending order by temperature into A1, A2, A3, . . . , Ai, . . . , AI;

a second sorting module for sorting the J low-temperature components in an ascending order by temperature into B1, B2, B3, . . . , Bj, . . . , BJ;

a comparison module of high-temperature and low-temperature components for comparing the number I of high-temperature components with the number J of low-temperature components, wherein if I>J, computing resource allocation tasks are performed for the high-temperature components A1, A2, A3, . . . , Aj, . . . , AJ and the low-temperature components B1, B2, B3, . . . , Bj, . . . , BJ according to a data allocation module, if I<J, computing resource allocation tasks are performed for the high-temperature components A1, A2, A3, . . . , Ai, . . . , AI and the low-temperature components B1, B2, B3, . . . , Bi, . . . , BI according to the data allocation module; and

the data allocation module for, when I=J, allocating 10% of the computing resources of the high-temperature component A1 to the low-temperature component B1, allocating 10% of the computing resources of the high-temperature component A2 to the low-temperature component B2, allocating 10% of the computing resources of the high-temperature component A3 to the low-temperature component B3, . . . , allocating 10% of the computing resources of the high-temperature component Ai to the low-temperature component Bj, . . . , allocating 10% of the computing resources of the high-temperature component AI to the low-temperature component BJ.

By using the method and the system for reducing power consumption by automatically allocating computing resources on the basis of component temperature described herein, the following problem can be avoided: in actual operation, all devices are allocated with the same amount of resource loading, in the case that environmental conditions are different and the computing resources are allocated evenly, local temperature of the devices at positions under boundary conditions of higher incoming flow temperature and lower wind speed is too high, and thus the rotating speed of the fan is rapidly increased.

The present invention not only can effectively and reasonably allocate the computing resources and ensure sufficient computing amount, but also can effectively reduce the power consumption of the whole system. Self-regulation of loading resources of the machine can be realized for different operating environments, such an arrangement is more reasonable and intelligent.

The foregoing is only preferred embodiments of the present invention, and those skilled in the art can make various modifications and adaptations without departing from the principle of the present invention and these modifications and adaptations also fall within the scope of the present invention.

1. A method for reducing power consumption by automatically allocating computing resources on the basis of component temperature, comprising:
S1, acquiring temperature values of N components of the same type at a current sampling time;
S2, calculating an average temperature value T of the components of the same type at the current sampling time, determining an upper temperature threshold Tmax and a lower temperature threshold Tmin, wherein the upper temperature threshold Tmax=T+3° C., the lower temperature threshold Tmin=T−3° C.;
S3, determining a high-temperature component Ai, a low-temperature component Bj and a normal-temperature component Ck, wherein i is a serial number of the high-temperature component among a total of I high-temperature components; j is a serial number of the low-temperature component among a total of J high-temperature components; k is a serial number of the normal-temperature component among a total of K high-temperature components; and 0≤i≤I, 0≤j≤J, 0≤k≤K, I+J+K=N;
S4, allocating 10% of computing resources of the high-temperature component Ai to the low-temperature component Bj, wherein the components continuously run for one cycle after the allocation; and
S5, repeating the S1-54.

2. The method for reducing power consumption by automatically allocating computing resources on the basis of component temperature according to claim 1, wherein in the S3, a method of determining the high-temperature component Ai, the low-temperature component Bj and the normal-temperature component Ck comprises:
531, determining whether a temperature value of a single component is >Tmax, when yes, regarding the single component as the high-temperature component Ai;
S32, determining whether a temperature value of a single component is <Tmin, when yes, regarding the single component as the low-temperature component Bj; and
S33, determining whether Tmin≤a temperature value of a single component Tmax, when yes, regarding the single component as the normal-temperature component.

3. The method for reducing power consumption by automatically allocating computing resources on the basis of component temperature according to claim 1, wherein in the S4, a method of allocating 10% of the computing resources of the high-temperature component Ai to the low-temperature component Bj comprises:
S41, sorting the I high-temperature components in a descending order by temperature into A1 through AI;
S42, sorting the J low-temperature components in an ascending order by temperature into B1 through BJ;
S43, when I>J, allocating 10% of the computing resources of the high-temperature components A1, A2, A3, . . . , Aj, . . . , AJ to the low-temperature components B1 through BJ according to S45;
S44, when I<J, allocating 10% of the computing resources of the high-temperature components A1, A2, A3, . . . , Ai, . . . , AI to the low-temperature components B1 through BI according to S45; and
S45, when I=J allocating 10% of the computing resources of each of the high-temperature components A1 through AI respectively to each of the low-temperature component B1 through BJ.

4. The method for reducing power consumption by automatically allocating computing resources on the basis of component temperature according to claim 1, wherein the N components of the same type in the method are central processing units (CPUs), graphics processing units (GPUs) or peripheral component interconnect expresses (PCIEs), N≥2.

5. The method for reducing power consumption by automatically allocating computing resources on the basis of component temperature according to claim 1, wherein the one cycle of the method is 1 min.

6.-8. (canceled)
